(19) United States
(12) Patent Application Publication
(10) Pub. No.: US 2018/0024661 A1
(43) Pub. Date: Jan. 25, 2018

(54) METHOD FOR PERFORMING DISPLAY STABILIZATION CONTROL IN AN ELECTRONIC DEVICE WITH AID OF MICROELECTROMECHANICAL SYSTEMS, AND ASSOCIATED APPARATUS

(71) Applicant: MEDIATEK INC., Hsin-Chu (TW)

(72) Inventors: Chun-Yi Lin, Kaohsiung City (TW); Sheng-Hung Lai, New Taipei City (TW)

(21) Appl. No.: 15/215,526

(22) Filed: Jul. 20, 2016

(51) Int. Cl. G06F 3/041

(52) U.S. Cl. CPC G06F 3/041; G06F 3/0418

(57) ABSTRACT

A method for performing display stabilization control in an electronic device and an associated apparatus are provided, where the method may include the steps of: receiving a detection signal from at least one sensing component of the electronic device, such as at least one micro-electro-mechanical system (MEMS) sensor, to determine a movement of the electronic device according to the detection signal; determining a reverse-movement that is opposite to the movement of the electronic device; and adjusting at least one location of at least one portion of display contents on a display module (e.g. a touch-sensitive display module) of the electronic device according to the reverse-movement, to emulate a stabilized version of the at least one portion of the display contents for a user of the electronic device.

### BACKGROUND

The present invention relates to screen content stabilization control of an electronic device, and more particularly, to a method for performing display stabilization control in an electronic device, and an associated apparatus.

According to the related art, a conventional electronic device such as a multifunctional mobile phone may be designed to have a display module. Based on this design, the user of the conventional electronic device may obtain visual information from the display module. In some cases, the display module may be a touch-sensitive display module so that the user may apply touch input to the display module, in order to interact with the conventional electronic device. However, in a situation where the user is moving from one place to another place, some problems may occur when using the conventional electronic device. For example, when the user is walking or jogging and may need to have a glance at an electronic map displayed on the display module, everything on the electronic map may be shaking, causing inconvenience and/or bad viewing experience. In another example, when the user is on a bus and is reading something displayed by the display module, the contents displayed on the display module may be shaking, and his/her eyes may need to follow the shaking contents in various moments, causing the user to experience discomfort. In another example, when the user is on a bus and is trying to input information into the conventional electronic device through the user interface (UI) displayed on the display module, it is hard for the user to correctly type some texts or to align his/her finger to a control object of the UI, such as a login button. Thus, a novel method and associated architecture are required for performing display stabilization control of electronic devices, in order to bring better user experience to a user such as that mentioned above.

### SUMMARY

It is an objective of the claimed invention to provide a method for performing display stabilization control in an electronic device, and an associated apparatus, in order to solve the above-mentioned problems.

It is another objective of the claimed invention to provide a method for performing display stabilization control in an electronic device, and an associated apparatus, in order to bring better user experience to a user.

According to at least one preferred embodiment, a method for performing display stabilization control in an electronic device is provided, where the method may comprise the steps of: receiving a detection signal from at least one sensing component (e.g. one or more sensing components) of the electronic device, such as at least one micro-electro-mechanical system (MEMS) sensor (e.g. one or more MEMS sensors), to determine a movement of the electronic device according to the detection signal; determining a reverse-movement that is opposite to the movement of the electronic device; and adjusting at least one location of at least one portion (e.g. a portion or all) of display contents on a display module (e.g. a touch-sensitive display module) of the electronic device according to the reverse-movement, to emulate a stabilized version of the at least one portion of the display contents for a user of the electronic device. In some embodiments, the method may further comprise: before determining the movement of the electronic device, receiving a previous detection signal from the at least one sensing component of the electronic device to detect an initial orientation of the electronic device, wherein the movement of the electronic device is determined with respect to the initial orientation of the electronic device. For example, the step of receiving the detection signal from the at least one sensing component of the electronic device to determine the movement of the electronic device according to the detection signal may further comprise: receiving the detection signal from the at least one sensing component to determine a temporary orientation of the electronic device; and comparing the temporary orientation with the initial orientation to determine the movement of the electronic device. In another example, the initial orientation of the electronic device may comprise at least one initial angle (e.g. one or more initial angles) of at least one axis (e.g. one or more axes) of the electronic device with respect to a coordinate system of real space.

In some embodiments, the movement of the electronic device may comprise one or a combination of at least one rotation vector (e.g. one or more rotation vectors) and at least one shift vector (e.g. one or more shift vectors), and the reverse-movement may comprise at least one vector (e.g. one or more vectors) that reduces or cancels at least one (e.g. one or more) of the at least one rotation vector and the at least one shift vector. In some embodiments, the step of adjusting according to the reverse-movement may reduce or cancel a blur effect corresponding to the movement of the electronic device for the user. In some embodiments, the method may further comprise: detecting whether at least one condition (e.g. one or more conditions) of the electronic device is satisfied to determine whether to trigger the step of adjusting according to the reverse-movement, wherein the at least one condition is related to one or a combination of a shaking frequency of the electronic device, a motion speed of the electronic device, a rotation angle of the electronic device, a predetermined application, and a predetermined button of the electronic device. For example, the step of detecting whether the at least one condition of the electronic device is satisfied to determine whether to trigger the step of adjusting according to the reverse-movement may comprise at least one (e.g. one or more) of the following: determining whether the shaking frequency of the electronic device reaches a predetermined frequency threshold; determining whether the motion speed of the electronic device reaches a predetermined speed threshold; determining whether the rotation angle of the electronic device falls within a predetermined range; determining whether the predetermined application is running on the electronic device; and determining whether the predetermined button of the electronic device is pressed. In some embodiments, the at least one portion of the display contents may comprise a control object of a user interface (UI) displayed on the display module and the display module may be a touch-sensitive display module, and the method may further comprise: when adjusting the at least one location of the at least one portion of the display contents on the display module according to the reverse-movement, adjusting a location of a detection region of the control object correspondingly, to allow the user to touch the detection region without need of resisting shaking of the electronic device. For example, the method may further comprise: enlarging the control object and the detection region thereof on the touch-sensitive display module to increase a probability of successfully touching the detection region by the user. In some embodiments, the method may further comprise: enlarging at least one portion of display contents on the display module of the electronic device, such as the aforementioned at least one portion of the display contents in the step of adjusting according to the reverse-movement.

According to at least one preferred embodiment, an apparatus for performing display stabilization control in an electronic device is provided, where the apparatus may comprise at least one portion (e.g. a portion or all) of the electronic device. For example, the apparatus may comprise a processing circuit that is positioned in the electronic device and coupled to at least one sensing component (e.g. one or more sensing components) of the electronic device, such as at least one MEMS sensor (e.g. one or more MEMS sensors). The processing circuit may be arranged for receiving a detection signal from the at least one sensing component of the electronic device to determine a movement of the electronic device according to the detection signal, determining a reverse-movement that is opposite to the movement of the electronic device, and adjusting at least one location of at least one portion (e.g. a portion or all) of display contents on a display module (e.g. a touch-sensitive display module) of the electronic device according to the reverse-movement, to emulate a stabilized version of the at least one portion of the display contents for a user of the electronic device. In some embodiments, before determining the movement of the electronic device, the processing circuit may receive a previous detection signal from the at least one sensing component of the electronic device to detect an initial orientation of the electronic device, wherein the movement of the electronic device is determined with respect to the initial orientation of the electronic device. For example, the processing circuit may receive the detection signal from the at least one sensing component to determine a temporary orientation of the electronic device, and may compare the temporary orientation with the initial orientation to determine the movement of the electronic device. In another example, the initial orientation of the electronic device may comprise at least one initial angle (e.g. one or more initial angles) of at least one axis (e.g. one or more axes) of the electronic device with respect to a coordinate system of real space.

In some embodiments, the movement of the electronic device may comprise one or a combination of at least one rotation vector (e.g. one or more rotation vectors) and at least one shift vector (e.g. one or more shift vectors), and the reverse-movement may comprise at least one vector (e.g. one or more vectors) that reduces or cancels at least one (e.g. one or more) of the at least one rotation vector and the at least one shift vector. In some embodiments, the operation of adjusting according to the reverse-movement may reduce or cancel a blur effect corresponding to the movement of the electronic device for the user. In some embodiments, the processing circuit may detect whether at least one condition (e.g. one or more conditions) of the electronic device is satisfied to determine whether to trigger the operation of adjusting according to the reverse-movement, wherein the at least one condition is related to one or a combination of a shaking frequency of the electronic device, a motion speed of the electronic device, a rotation angle of the electronic device, a predetermined application, and a predetermined button of the electronic device. For example, when detecting whether the at least one condition of the electronic device is satisfied to determine whether to trigger the operation of adjusting according to the reverse-movement, the processing circuit may perform at least one (e.g. one or more) of the following: determining whether the shaking frequency of the electronic device reaches a predetermined frequency threshold; determining whether the motion speed of the electronic device reaches a predetermined speed threshold; determining whether the rotation angle of the electronic device falls within a predetermined range; determining whether the predetermined application is running on the electronic device; and determining whether the predetermined button of the electronic device is pressed. In some embodiments, the at least one portion of the display contents may comprise a control object of a user interface (UI) displayed on the display module and the display module may be a touch-sensitive display module. In addition, when adjusting the at least one location of the at least one portion of the display contents on the display module according to the reverse-movement, the processing circuit may adjust a location of a detection region of the control object correspondingly, to allow the user to touch the detection region without need of resisting shaking of the electronic device. For example, the processing circuit may enlarge the control object and the detection region thereof on the touch-sensitive display module to increase a probability of successfully touching the detection region by the user. In some embodiments, the processing circuit may enlarge at least one portion of display contents on the display module of the electronic device, such as the aforementioned at least one portion of the display contents in operation of adjusting according to the reverse-movement.

It is an advantage of the present invention that the present invention method and the associated apparatus can bring better user experience to a user, and the related art problems (e.g. the problem of having trouble reading the electronic map during walking or jogging, the problem that the eyes should follow the shaking contents in various moments, the problem of typing incorrect texts, and the problem of having trouble aligning the finger to the login button) may no longer be an issue. In addition, the present invention method and the associated apparatus can enlarge at least one portion of display contents on the display module of the electronic device and/or enlarge at least one control object (e.g. one or more control objects) of the UI displayed on the touch-sensitive display module when needed, to increase the probability of correctly touching an input field displayed on the display module and/or the aforementioned at least one control object. As a result, the user may input information into the electronic device with ease on a bus or another vehicle.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an apparatus for performing display stabilization control in an electronic device according to an embodiment of the present invention.

FIG. 2 illustrates a mobile phone involved with the apparatus shown in FIG. 1 according to an embodiment of the present invention.

FIG. 3 illustrates a screen content stabilization control scheme involved with the apparatus shown in FIG. 1 according to an embodiment of the present invention.

FIG. 4 illustrates a hybrid control scheme involved with the apparatus shown in FIG. 1 according to an embodiment of the present invention.

FIG. 5 illustrates an initial state involved with the screen content stabilization control scheme shown in FIG. 3 according to an embodiment of the present invention.

FIG. 6 illustrates a temporary state involved with the screen content stabilization control scheme shown in FIG. 3 according to an embodiment of the present invention.

FIG. 7 illustrates a temporary state involved with the screen content stabilization control scheme shown in FIG. 3 according to another embodiment of the present invention.

FIG. 8 illustrates variations of some rotation vectors involved with the screen content stabilization control scheme shown in FIG. 3 according to an embodiment of the present invention.

FIG. 9 illustrates variations of some shift vectors involved with the screen content stabilization control scheme shown in FIG. 3 according to an embodiment of the present invention.

FIG. 10 illustrates a flowchart of a method for performing display stabilization control in an electronic device according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

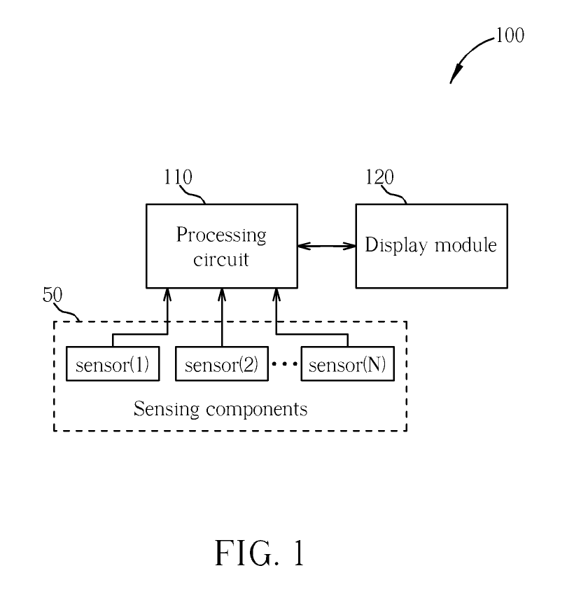

FIG. 1 illustrates a diagram of an apparatus 100 for performing display stabilization control in an electronic device according to an embodiment of the present invention, where the apparatus 100 may comprise at least one portion (e.g. a portion or all) of the electronic device. The apparatus 100 may comprise a portion of the electronic device mentioned above, and for example, can be at least one hardware circuit such as at least one integrated circuit (IC) within the electronic device and associated circuits thereof. In another example, the apparatus 100 can be the whole of the electronic device mentioned above. In another example, the apparatus 100 may comprise a system comprising the electronic device mentioned above (e.g. a wireless communications system comprising the electronic device). Examples of the electronic device may include, but not limited to, a mobile phone (e.g. a multifunctional mobile phone), a tablet, a wearable electronic device (e.g. a watch, glasses, etc.), an Internet of Things (IoT) device and a personal computer such as a laptop computer.

As shown in FIG. 1, the apparatus 100 may comprise a processing circuit 110 that is positioned in the electronic device and coupled to at least one sensing component of the electronic device. For example, the sensing component may be a micro-electro-mechanical system (which may also be referred to as microelectromechanical system, MEMS) component, such as at least one MEMS sensor (e.g. one or more MEMS sensors). For example, the aforementioned at least one sensing component may comprise a plurality of sensing components 50 such as N sensors (labeled sensor(1), sensor(2), . . . , and sensor(N) in FIG. 1, for brevity). Examples of the sensors may include, but not limited to, accelerometers, gyroscopes, magnetometers, and pressure sensors. In addition, the processing circuit 110 may comprise at least one processor (e.g. one or more processors) arranged for running at least one program module (e.g. one or more program modules), and the program module(s) running on the aforementioned at least one processor may control operations of the electronic device. According to some embodiments, at least one portion (e.g. a portion or all) of the processing circuit 110 may be implemented with a customized semiconductor chip such as an application-specific integrated circuit (ASIC). For better comprehension, a display module 120 of the electronic device is illustrated in the architecture shown in FIG. 1. In some embodiments, the display module 120 can be a touch-sensitive display module. Please note that, in some embodiments, the apparatus 100 may comprise only a portion of the architecture shown in FIG. 1.

According to this embodiment, the processing circuit 110 may be arranged for receiving one or more detection signals from the sensing components sensor(1), sensor(2), . . . , and sensor(N) to determine a movement of the electronic device according to the detection signal(s). For example, before determining the movement of the electronic device, the processing circuit 110 may receive one or more previous detection signals from the sensing components sensor(1), sensor(2), . . . , and sensor(N) to detect an initial orientation of the electronic device, where the movement of the electronic device is determined with respect to the initial orientation of the electronic device. In addition, the processing circuit 110 may be arranged for determining a reverse-movement that is opposite to the movement of the electronic device. For example, the movement of the electronic device may comprise one or a combination of at least one rotation vector (e.g. one or more rotation vectors, such as the rotation vectors MRx(1), MRy(1), and MRz(1) respectively corresponding to an X-axis, a Y-axis, and a Z-axis of a coordinate system of the real space where the electronic device is positioned) and at least one shift vector (e.g. one or more shift vectors, such as the shift vectors MSx(1), MSy(1), and MSz(1) respectively corresponding to the X-axis, the Y-axis, and the Z-axis), and the reverse-movement may comprise at least one vector (e.g. one or more vectors) that reduces or cancels at least one (e.g. one or more) of the at least one rotation vector and the at least one shift vector. For better comprehension, the movement of the electronic device may be expressed with the rotation vectors MRx(1), MRy(1), and MRz(1) and the shift vectors MSx(1), MSy(1), and MSz(1) (e.g. one or more of the rotation vectors MRx(1), MRy(1), and MRz(1) may be zero, and/or one or more of the shift vectors MSx(1), MSy(1), and MSz(1) may be zero), and the reverse-movement may be expressed with the rotation vectors MRx(2), MRy(2), and MRz(2) and the shift vectors MSx(2), MSy(2), and MSz(2). In one example, MRx(2)=−MRx(1), MRy(2)=−MRy(1), MRz(2)=−MRz(1), MSx(2)=−MSx(1), MSy(2)=−MSy(1), and MSz(2)=−MSz(1). Additionally, the processing circuit 110 may be arranged for adjusting at least one location of at least one portion (e.g. a portion or all) of display contents on the display module 120 according to the reverse-movement, to emulate a stabilized version of the aforementioned at least one portion of the display contents for a user of the electronic device. For example, the step of adjusting according to the reverse-movement (e.g. the operation of adjusting according to the reverse-movement) may reduce or cancel a blur effect corresponding to the movement of the electronic device for the user. According to some embodiments, one or more existing sensor fusion methods may be applied to obtaining of the movement of the electronic device. For example, there may be some advantages and disadvantages regarding using only a portion of the sensing components sensor(1), sensor(2), . . . , and sensor(N) (e.g. one or more accelerometers, one or more gyroscopes, one or more magnetometers, and/or one or more pressure sensors), and the sensor fusion methods may solve some key motion sensing performance issues of six-axis modules consisting of a three-axis accelerometer and a three-axis gyroscope or a three-axis accelerometer and a three-axis magnetic sensor.

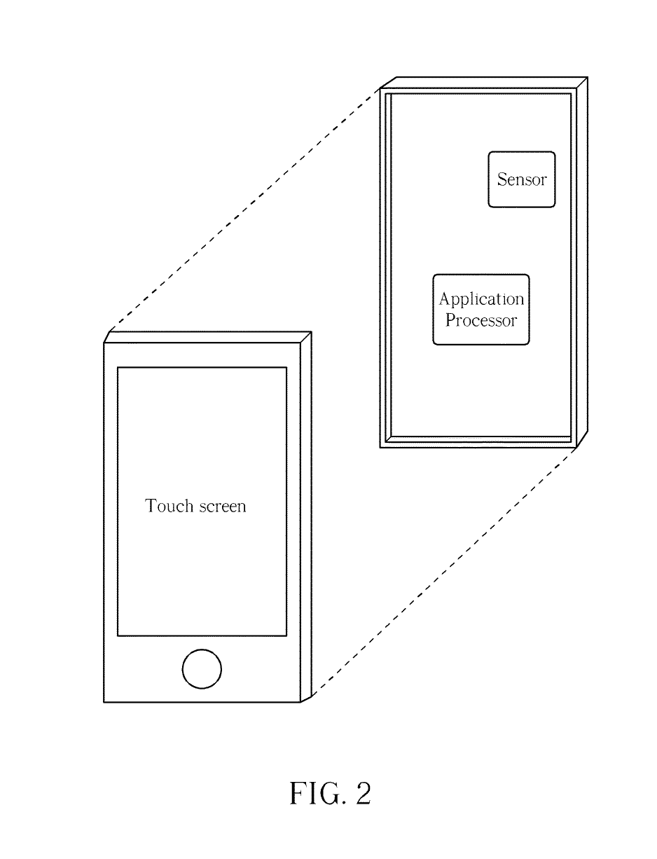

FIG. 2 illustrates a mobile phone involved with the apparatus 100 shown in FIG. 1 according to an embodiment of the present invention, where the mobile phone (e.g. the multifunctional mobile phone) can be taken as an example of the electronic device mentioned above. As shown in FIG. 2, the mobile phone may comprise a touch screen, which can be taken as an example of the display module 120 shown in FIG. 1. In addition, the internal components of the mobile phone may comprise an application processor chip (labeled “Application Processor” in FIG. 2, for brevity) and a sensor chip (labeled “Sensor” in FIG. 2, for brevity). The aforementioned at least one processor may be implemented within the application processor chip, and the sensing components sensor(1), sensor(2), . . . , and sensor(N) may be implemented within the sensor chip. For brevity, similar descriptions for this embodiment are not repeated in detail here.

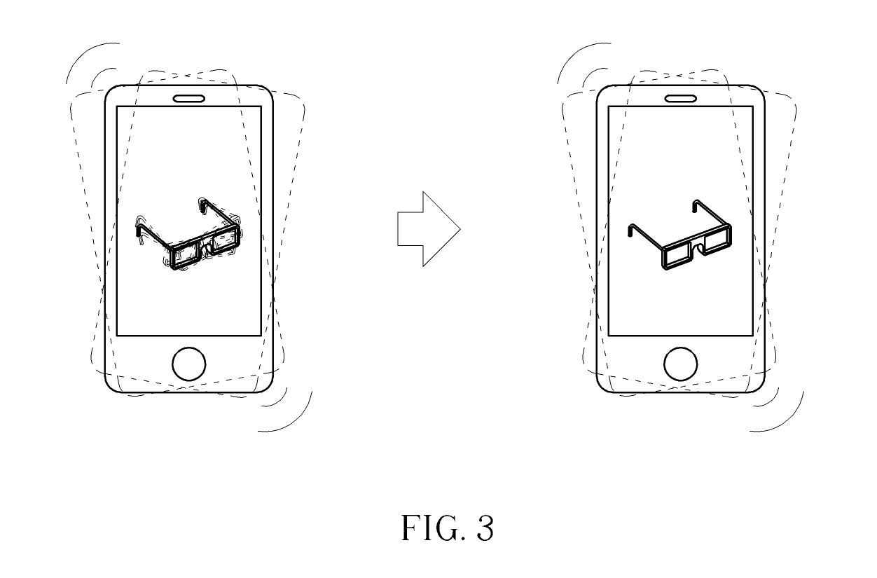

FIG. 3 illustrates a screen content stabilization control scheme involved with the apparatus 100 shown in FIG. 1 according to an embodiment of the present invention. As shown in the left half of FIG. 3, a conventional electronic device is not implemented to have the capability of performing the step of adjusting according to the reverse-movement (e.g. the operation of adjusting according to the reverse-movement), and when the conventional electronic device is shaking (e.g. somebody using the conventional electronic device is holding the conventional electronic device with one of his/her hands, for example, on the bus), everything on the screen thereof seems to be also shaking, causing the related art problems mentioned above. In comparison with this, an electronic product implemented according to the present invention, such as the electronic device mentioned in any of the embodiments respectively shown in FIGS. 1-2, is equipped with the capability of performing the step of adjusting according to the reverse-movement (e.g. the operation of adjusting according to the reverse-movement). Based upon the screen content stabilization control scheme, when the electronic device such as the mobile phone shown in FIG. 2 is shaking, the step of adjusting according to the reverse-movement (e.g. the operation of adjusting according to the reverse-movement) may reduce or cancel the blur effect corresponding to the movement of the electronic device for the user, as shown in the right half of FIG. 3. For brevity, similar descriptions for this embodiment are not repeated in detail here.

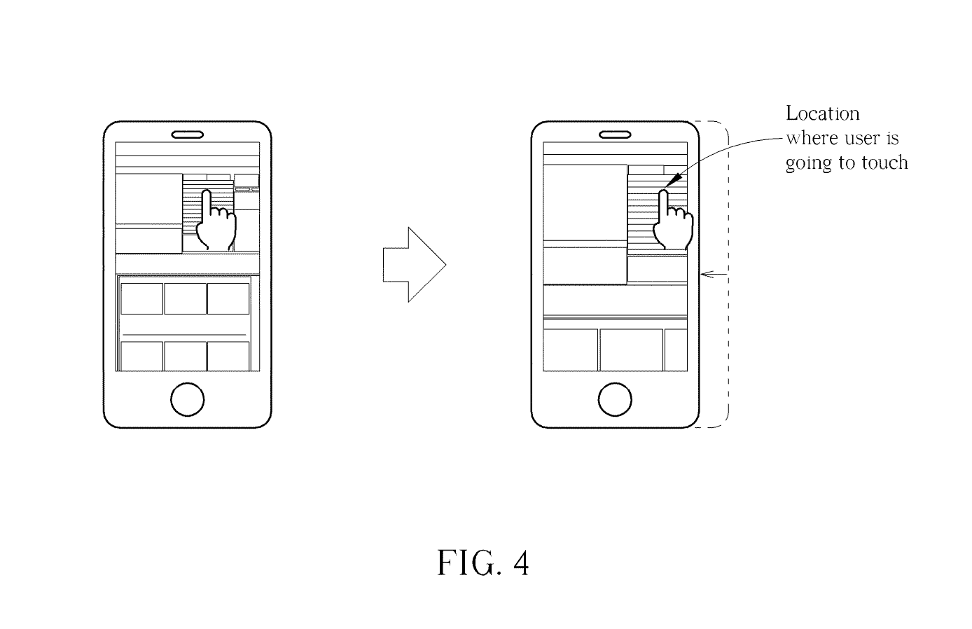

FIG. 4 illustrates a hybrid control scheme involved with the apparatus 100 shown in FIG. 1 according to an embodiment of the present invention. The hybrid control scheme of this embodiment may comprise the screen content stabilization control scheme shown in FIG. 3, and may further comprise a zoom in control scheme. As shown in the left half of FIG. 4, the electronic device such as the mobile phone shown in FIG. 2 (e.g. the multifunctional mobile phone) may be in a normal condition without shaking. For example, the user of the electronic device such as the multifunctional mobile phone may be holding the electronic device with one of his/her hands, for example, the left hand, and is using the electronic device on the bus. In a situation where there is no shaking, the user may easily use his/her finger to input text or touch a certain control object of the user interface (UI) displayed on the display module 120 (e.g. the touch screen). For example, the UI may comprise a control menu within a web-page, and the control object of the UI may be an item in the control menu. As shown in the right half of FIG. 4, in a situation where the electronic device such as the mobile phone shown in FIG. 2 is shaking (e.g. the user of the electronic device is holding the electronic device with one of his/her hands, and is using the electronic device on the bus), the aforementioned movement of the electronic device, may be detected. Besides, for example, by utilizing one or more of the display module 120 (e.g. the touch screen), a front camera of the electronic device, and an ambient light sensor of the electronic device, the processing circuit 110 may detect that the user will have the touch-control behavior and may detect the location where the user is going to touch on the display module 120. According to some embodiments, the processing circuit 110 may detect that the user will have the touch-control behavior and may detect the location where the user is going to touch according to the electric field variations around the surface of the touch screen, where the electric field variations may be detected with aid of the touch detection components in the touch screen. According to some embodiments, the processing circuit 110 may detect that the user will have the touch-control behavior according to the images captured by the front camera through image recognition. According to some embodiments, the processing circuit 110 may detect that the user will have the touch-control behavior according to the ambient light variations around the surface of the touch screen, where the ambient light variations may be detected with aid of the ambient light sensor.

As shown in the right half of FIG. 4, the movement of the electronic device such as the mobile phone shown in FIG. 2 (e.g. the multifunctional mobile phone) can be a shift in the horizontal direction, and the processing circuit 110 may perform shift compensation on the displayed contents displayed on the touch screen according to the screen content stabilization control scheme shown in FIG. 3. In addition to the step of adjusting according to the reverse-movement (for example, the shift compensation in this embodiment), the processing circuit 110 is capable of further performing the zoom in processing regarding the zoom in control scheme. When detecting that the user will have the touch-control behavior, the processing circuit 110 may enable the zoom in processing regarding the zoom in control scheme. For example, when adjusting the at least one location of the aforementioned at least one portion of the display contents on the display module 120 according to the reverse-movement, the processing circuit 110 may adjust the location of a detection region of the control object correspondingly, and for example, may adjust the location of the detection region to match the control object, so the control object and the detection region thereof are at the same place, to allow the user to touch the detection region without need of resisting shaking of the electronic device. In addition, based on the hybrid control scheme (for example, the zoom in control scheme), the processing circuit 110 may enlarge at least one portion of display contents on the display module of the electronic device, such as the aforementioned at least one portion of the display contents in the step of adjusting according to the reverse-movement (e.g. the operation of adjusting according to the reverse-movement). In one embodiment, the processing circuit 110 may enlarge an input field displayed on the display module 120 (e.g. a box for the user to input texts, etc. that is displayed on the display module 120) to increase the probability of successfully touching the input field by the user. For example, the processing circuit 110 may enlarge the input field, and may perform shift compensation on the enlarged version of the input field according to the movement of the electronic device, so the user may touch the latest input field (e.g. the enlarged version of the input field) easily and correctly without need of resisting shaking of the electronic device. In another embodiment, the processing circuit 110 may enlarge the control object and the detection region thereof on the display module 120 to increase the probability of successfully touching the detection region by the user. For example, the processing circuit 110 may enlarge the whole control menu and/or the whole web-page, and may perform shift compensation on the enlarged version of the whole control menu and/or the whole web-page according to the movement of the electronic device, so the user may touch the detection region of the item in the control menu easily and correctly without need of resisting shaking of the electronic device. As a result, the related art problems (e.g. the problem of having trouble reading the electronic map during walking or jogging, the problem that the eyes should follow the shaking contents in various moments, the problem of typing incorrect texts, and the problem of having trouble aligning the finger to the login button) may no longer be an issue. For brevity, similar descriptions for this embodiment are not repeated in detail here.

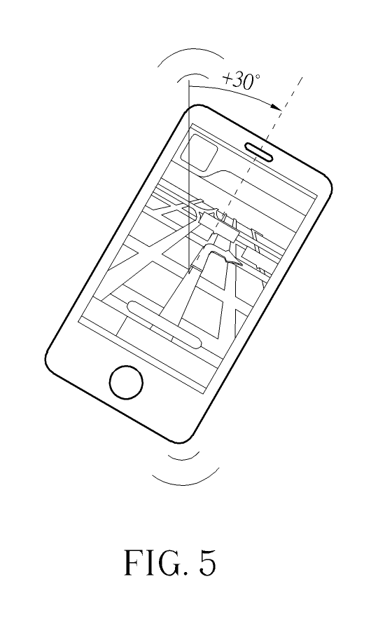

FIG. 5 illustrates an initial state involved with the screen content stabilization control scheme shown in FIG. 3 according to an embodiment of the present invention. For example, the user of the electronic device such as the multifunctional mobile phone is holding the electronic device with one of his/her hands, and is using the electronic device on the way to somewhere (e.g. the user may need to have a glance at an electronic map displayed on the display module 120). As mentioned above, the processing circuit 110 may receive one or more previous detection signals from the sensing components sensor(1), sensor(2), . . . , and sensor(N) to determine the initial orientation of the electronic device, such as the initial orientation illustrated with the dashed line shown in FIG. 5 (e.g. the dashed line deviated from the vertical line with +30 degrees, where the vertical line may represent the Y-axis of the coordinate system of the real space). According to this embodiment, the initial orientation of the electronic device may comprise at least one initial angle (e.g. one or more initial angles) of at least one axis (e.g. one or more axes) of the electronic device with respect to the coordinate system of the real space where the electronic device is positioned. For example, the electronic device such as the mobile phone shown in FIG. 2 (e.g. the multifunctional mobile phone) may start shaking due to the environment (e.g. the user may be on the bus), and once the shaking is detected, the processing circuit 110 may detect that the angle of the vertical axis of the mobile phone is +30 degrees with respect to the Y-axis of the coordinate system of the real space. In this embodiment, the direction of the vertical axis of the mobile phone (e.g. the dashed line deviated from the vertical line with +30 degrees) at this moment can be utilized as the initial orientation of the electronic device, and the angle of +30 degrees can be taken as an example of the aforementioned at least one initial angle of the initial orientation of the electronic device. This is for illustrative purposes only, and is not meant to be a limitation of the present invention. According to some embodiments, the initial orientation of the electronic device may comprise multiple initial angles, such as multiple angles measured with respect to multiple axes of the coordinate system of the real space, respectively. In the embodiment shown in FIG. 5, the processing circuit 110 may record the angle of +30 degrees and utilize the angle of +30 degrees as an initial angle within the aforementioned at least one initial angle of the initial orientation, for use of further processing regarding the step of adjusting according to the reverse-movement (e.g. the operation of adjusting according to the reverse-movement).

According to some embodiments, the processing circuit 110 may detect whether at least one condition (e.g. one or more conditions) of the electronic device is satisfied to determine whether to trigger the step of adjusting according to the reverse-movement (e.g. the operation of adjusting according to the reverse-movement), where the aforementioned at least one condition may be related to one or a combination of a shaking frequency of the electronic device, a motion speed of the electronic device, a rotation angle of the electronic device, a predetermined application, and a predetermined button of the electronic device. The predetermined button can be a virtual button or a physical button. For example, when detecting whether the aforementioned at least one condition of the electronic device is satisfied to determine whether to trigger the step of adjusting according to the reverse-movement (e.g. the operation of adjusting according to the reverse-movement), the processing circuit may perform at least one (e.g. one or more) of the following: determining whether the shaking frequency of the electronic device reaches a predetermined frequency threshold; determining whether the motion speed of the electronic device reaches a predetermined speed threshold; determining whether the rotation angle of the electronic device falls within a predetermined range; determining whether the predetermined application is running on the electronic device; and determining whether the predetermined button of the electronic device is pressed. In one of these embodiments, when the shaking frequency of the electronic device reaches the predetermined frequency threshold, the processing circuit 110 may trigger the step of adjusting according to the reverse-movement (e.g. the operation of adjusting according to the reverse-movement). In one of these embodiments, when the motion speed of the electronic device reaches the predetermined speed threshold, the processing circuit 110 may trigger the step of adjusting according to the reverse-movement (e.g. the operation of adjusting according to the reverse-movement). In another of these embodiments, when the rotation angle of the electronic device falls within the predetermined range, the processing circuit 110 may trigger the step of adjusting according to the reverse-movement (e.g. the operation of adjusting according to the reverse-movement). In another embodiment, when the predetermined application is running on the electronic device, the processing circuit 110 may trigger the step of adjusting according to the reverse-movement (e.g. the operation of adjusting according to the reverse-movement). In yet another embodiment, when the predetermined button of the electronic device is pressed, the processing circuit 110 may trigger the step of adjusting according to the reverse-movement (e.g. the operation of adjusting according to the reverse-movement).

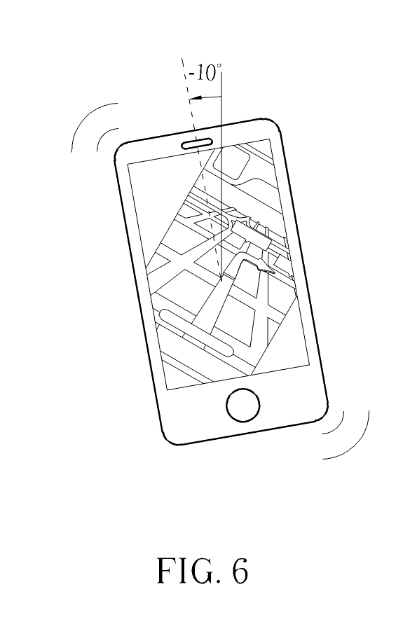

FIG. 6 illustrates a temporary state involved with the screen content stabilization control scheme shown in FIG. 3 according to an embodiment of the present invention. For example, the user of the electronic device such as the multifunctional mobile phone is holding the electronic device with one of his/her hands, and is using the electronic device on the way to somewhere (e.g. the user may need to have a glance at the electronic map displayed on the display module 120). The processing circuit 110 may receive the one or more detection signals from the sensing components sensor(1), sensor(2), . . . , and sensor(N) to determine a temporary orientation of the electronic device, such as the temporary orientation illustrated with the dashed line shown in FIG. 6 (e.g. the dashed line deviated from the vertical line with “−10” degrees, where the vertical line may represent the Y-axis of the coordinate system of the real space, and the negative sign of the angle of −10 degrees may correspond to the left side of the Y-axis in this embodiment), and may compare this temporary orientation with the initial orientation to determine the movement of the electronic device. According to this embodiment, the temporary orientation of the electronic device may comprise at least one temporary angle (e.g. one or more temporary angles) of at least one axis (e.g. one or more axes) of the electronic device with respect to the coordinate system of the real space where the electronic device is positioned. For example, the electronic device such as the mobile phone shown in FIG. 2 may be shaking due to the environment (e.g. the user may be on the bus), and the processing circuit 110 may detect that the angle of the vertical axis of the mobile phone is −10 degrees with respect to the Y-axis of the coordinate system of the real space. In this embodiment, the direction of the vertical axis of the mobile phone (e.g. the dashed line deviated from the vertical line with −10 degrees) at this moment can be utilized as the temporary orientation of the electronic device, and the angle of −10 degrees can be taken as an example of the aforementioned at least one temporary angle of the temporary orientation of the electronic device. This is for illustrative purposes only, and is not meant to be a limitation of the present invention. According to some embodiments, the temporary orientation of the electronic device may comprise multiple temporary angles, such as multiple angles measured with respect to multiple axes of the coordinate system of the real space, respectively. In the embodiment shown in FIG. 6, the processing circuit 110 may compare the angle of −10 degrees with the initial angle of the initial orientation of the electronic device (e.g. the aforementioned angle of +30 degrees in the embodiment shown in FIG. 5) to obtain the movement information of the movement. As a result, the processing circuit 110 may determine the reverse-movement correspondingly, and may further perform the step of adjusting according to the reverse-movement (e.g. the operation of adjusting according to the reverse-movement). For brevity, similar descriptions for this embodiment are not repeated in detail here.

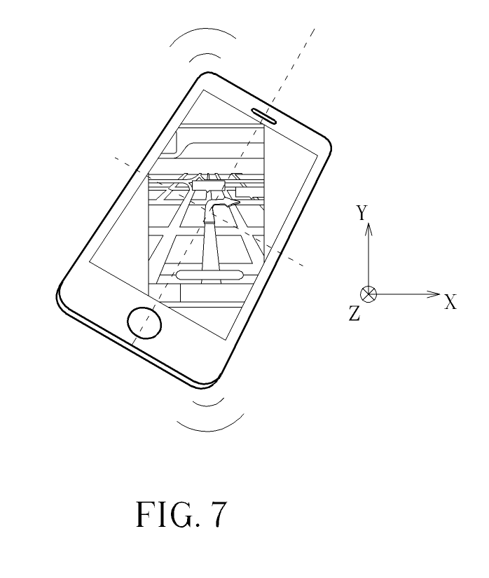

FIG. 7 illustrates a temporary state involved with the screen content stabilization control scheme shown in FIG. 3 according to another embodiment of the present invention. For example, the user of the electronic device such as the multifunctional mobile phone is holding the electronic device with one of his/her hands, and is using the electronic device on the way to somewhere (e.g. the user may need to have a glance at the electronic map displayed on the display module 120). The processing circuit 110 may receive the one or more detection signals from the sensing components sensor(1), sensor(2), . . . , and sensor(N) to determine a temporary orientation of the electronic device, such as that shown in FIG. 7, and may compare this temporary orientation with the initial orientation to determine the movement of the electronic device. According to this embodiment, the temporary orientation of the electronic device may comprise at least one temporary angle (e.g. one or more temporary angles) of at least one axis (e.g. one or more axes) of the electronic device with respect to the coordinate system of the real space where the electronic device is positioned. For example, the electronic device such as the mobile phone shown in FIG. 2 may be shaking due to the environment (e.g. the user may be on the bus), and the processing circuit 110 may detect that the angle of the vertical axis of the mobile phone with respect to the Y-axis of the coordinate system of the real space is a first value (e.g., in the unit of degrees) and that the angle of the vertical axis of the mobile phone with respect to the Z-axis of the coordinate system of the real space is a second value (e.g., in the unit of degrees), and may compare these angles with the initial angles regarding the Y-axis and the Z-axis of the coordinate system of the real space (e.g. the initial angles of the vertical axis of the mobile phone with respect to the Y-axis and the Z-axis of the coordinate system of the real space, respectively) to obtain the movement information of the movement. As a result, the processing circuit 110 may determine the reverse-movement correspondingly, and may further perform the step of adjusting according to the reverse-movement (e.g. the operation of adjusting according to the reverse-movement) to generate the adjusted display contents such as that shown in FIG. 7. For example, the adjusted display contents may be a partial map of an electronic map, and the normal direction (or the normal vector) of the partial map seems to be directed to the eyes of the user due to the step of adjusting according to the reverse-movement, although the normal direction (or the normal vector) of the touch screen is not directed to the eyes of the user during shaking. For brevity, similar descriptions for this embodiment are not repeated in detail here.

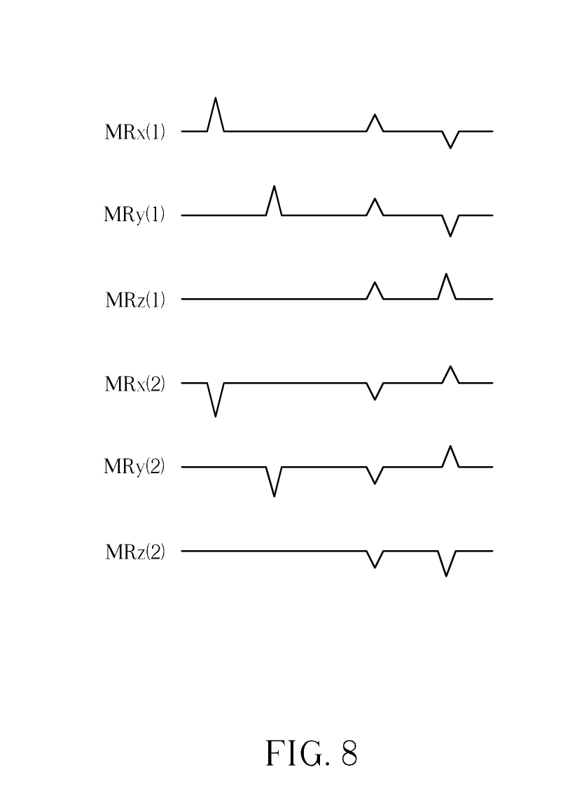

FIG. 8 illustrates variations of some rotation vectors involved with the screen content stabilization control scheme shown in FIG. 3 according to an embodiment of the present invention. For example, the curves of the rotation vectors {MRx(1), MRy(1), MRz(1)} and {MRx(2), MRy(2), MRz(2)} may indicate that MRx(2)=−MRx(1), MRy(2)=−MRy(1), and MRz(2)=−MRz(1). As a result, the step of adjusting according to the reverse-movement (e.g. the operation of adjusting according to the reverse-movement) may reduce or cancel the blur effect corresponding to the movement of the electronic device for the user. For brevity, similar descriptions for this embodiment are not repeated in detail here.

According to some embodiments, the processing circuit 110 may provide a parameter setting function to allow the user to adjust the relative strength of the reverse-movement with respect to the movement of the electronic device. For example, the processing circuit 110 may provide a parameter setting window to allow the user to adjust the ratio of the reverse-movement to the movement of the electronic device regarding the rotation vectors as follows:

MRx(2)=−MRx(1)*RR1;

MRy(2)=−MRy(1)*RR2; and

MRz(2)=−MRz(1)*RR3;

where the notations “RR1”, “RR2” and “RR3” may represent rotation vector ratio parameters corresponding to the ratio of the reverse-movement to the movement of the electronic device regarding the rotation vectors in X-axis, Y-axis and Z-axis, respectively. Depending on different embodiments, the rotation vector ratio parameters RR1, RR2 and RR3 may be of the same or different values.

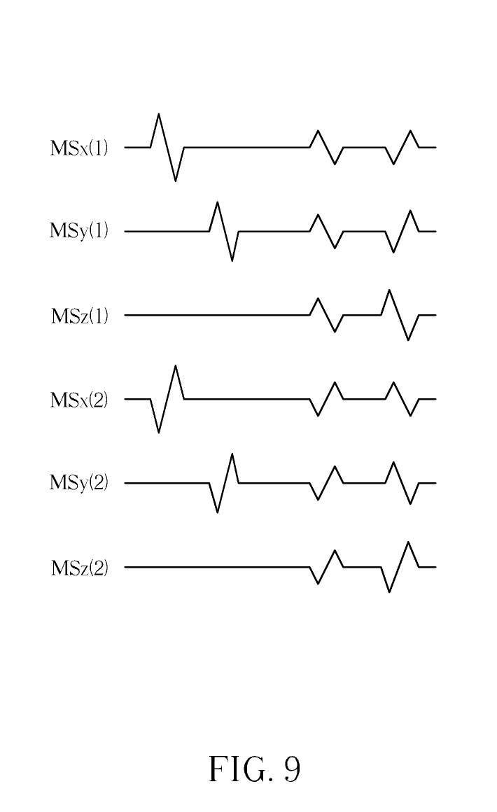

FIG. 9 illustrates variations of some shift vectors involved with the screen content stabilization control scheme shown in FIG. 3 according to an embodiment of the present invention. For example, the curves of the shift vectors {MSx(1), MSy(1), MSz(1)} and {MSx(2), MSy(2), MSz(2)} may indicate that MSx(2)=−MSx(1), MSy(2)=−MSy(1), and MSz(2)=−MSz(1). As a result, the step of adjusting according the reverse-movement (e.g. the operation of adjusting according to the reverse-movement) may reduce or cancel the blur effect corresponding to the movement of the electronic device for the user. For brevity, similar descriptions for this embodiment are not repeated in detail here.

According to some embodiments, the processing circuit 110 may provide a parameter setting function such as that mentioned above to allow the user to adjust the relative strength of the reverse-movement with respect to the movement of the electronic device. For example, the processing circuit 110 may provide a parameter setting window such as that mentioned above to allow the user to adjust the ratio of the reverse-movement to the movement of the electronic device regarding the shift vectors as follows:

MSx(2)=−MSx(1)*RS1;

MSy(2)=−MSy(1)*RS2; and

MSz(2)=−MSz(1)*RS3;

where the notations “RS1”, “RS2” and “RS3” may represent shift vector ratio parameters corresponding to the ratio of the reverse-movement to the movement of the electronic device regarding the shift vectors in X-axis, Y-axis and Z-axis, respectively. Depending on different embodiments, the shift vector ratio parameters RS1, RS2 and RS3 may be of the same or different values.

According to some embodiments, the shift vector ratio parameters RS1, RS2, and RS3 and the rotation vector ratio parameters RR1, RR2, and RR3 may be implemented as the same parameter such as a vector ratio parameter R. For example, the processing circuit 110 may provide a parameter setting window such as that mentioned above to allow the user to adjust the ratio of the reverse-movement to the movement of the electronic device regarding both of the rotation vectors and the shift vectors as follows:

MRx(2)=−MRx(1)*R;

MRy(2)=−MRy(1)*R;

MRz(2)=−MRz(1)*R;

MSx(2)=−MSx(1)*R;

MSy(2)=−MSy(1)*R; and

MSz(2)=−MSz(1)*R.

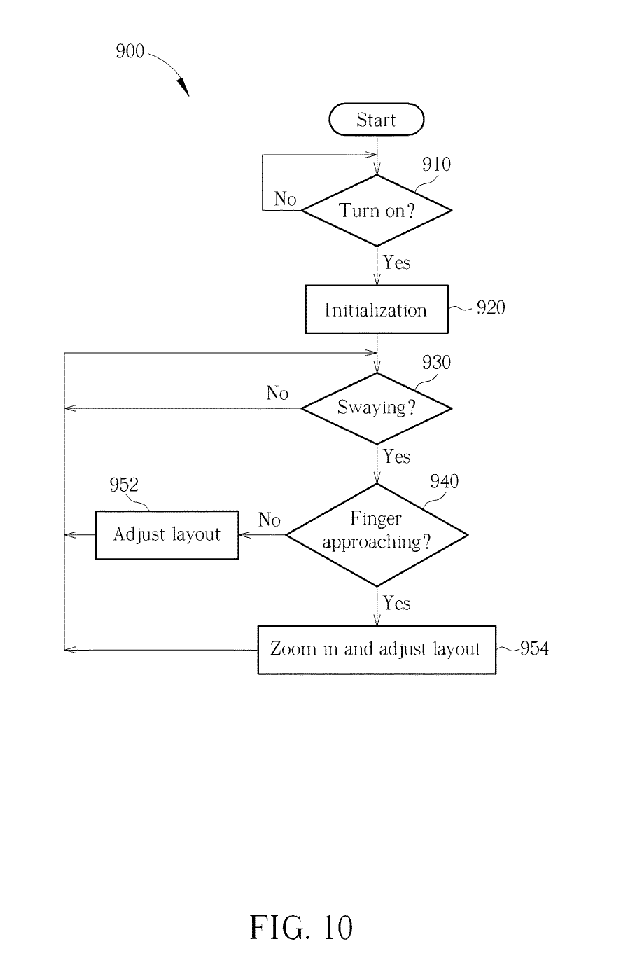

FIG. 10 illustrates a flowchart of a method 900 for performing display stabilization control in an electronic device according to an embodiment of the present invention. The method 900 shown in FIG. 10 can be applied to the apparatus 100 shown in FIG. 1 (e.g. the processing circuit 110), and can also be applied to the aforementioned at least one processor thereof and some program modules running on the processor. For example, the program modules may be provided through a computer program product having program instructions for instructing the aforementioned at least one processor to perform the method 900 shown in FIG. 10, where the computer program product may be implemented as a non-transitory computer-readable medium (e.g. a floppy disk or a compact disc-read only memory (CD-ROM)) storing the program instructions or an equivalent version thereof, such as a software package for being installed. The method can be described as follows.

In Step 910, the processing circuit 110 may check whether turning on the screen content stabilization function of the electronic device is required. For example, the processing circuit 110 may detecting whether the aforementioned at least one condition (e.g. one or more conditions) of the electronic device is satisfied to determine whether to turning on the screen content stabilization function. According to this embodiment, the aforementioned at least one condition may be related to one or a combination of the shaking frequency of the electronic device, the motion speed of the electronic device, the rotation angle of the electronic device, the predetermined application, and the predetermined button of the electronic device. The predetermined button can be a virtual button or a physical button. For example, the processing circuit 110 may detect that the electronic device is shaking, and may output a notification regarding this to ask the user to determine whether to turn on the screen content stabilization function. In another example, the processing circuit 110 may detect that the electronic device is shaking, and may automatically turn on the screen content stabilization function. When it is determined that turning on the screen content stabilization function of the electronic device is required, Step 920 is entered, to allow the screen content location compensation to be performed based on the screen content stabilization control scheme shown in FIG. 3; otherwise, Step 910 is re-entered.

In Step 920, the processing circuit 110 may perform one or more initialization operations (labeled “Initialization” in FIG. 10, for brevity). Examples of the initialization operations may include, but not limited to, the operation of receiving one or more previous detection signals from the sensing components sensor(1), sensor(2), . . . , and sensor(N) to determine the initial orientation of the electronic device, such as that shown in FIG. 5, and the operation of calculating the aforementioned at least one initial angle of the electronic device with respect to the coordinate system of the real space where the electronic device is positioned, where the angle of +30 degrees in the embodiment shown in FIG. 5 can be taken as an example of the aforementioned at least one initial angle of the initial orientation of the electronic device.

In Step 930, the processing circuit 110 may detect and check whether the electronic device is swaying. When it is detected that the electronic device is swaying (e.g. the processing circuit 110 may detect the movement of the electronic device with aid of the sensing components sensor(1), sensor(2), . . . , and sensor(N), indicating that the electronic device is swaying), Step 940 is entered; otherwise, Step 930 is re-entered.

In Step 940, the processing circuit 110 may check whether a finger of the user is approaching (labeled “Finger approaching” in FIG. 10, for brevity). For example, by utilizing one or more of the display module 120 (e.g. the touch screen), the front camera of the electronic device, and the ambient light sensor of the electronic device, the processing circuit 110 may detect that the finger of the user is approaching. According to some embodiments, the processing circuit 110 may detect that the finger of the user is approaching according to the electric field variations around the surface of the touch screen, where the electric field variations may be detected with aid of the touch detection components in the touch screen. According to some embodiments, the processing circuit 110 may detect that the finger of the user is approaching according to the images captured by the front camera through image recognition. According to some embodiments, the processing circuit 110 may detect that the finger of the user is approaching according to the ambient light variations around the surface of the touch screen, where the ambient light variations may be detected with aid of the ambient light sensor. When it is detected that the finger of the user is approaching, Step 954 is entered; otherwise, Step 952 is entered.

In Step 952, the processing circuit 110 may adjust the screen content layout (labeled “Adjust layout” in FIG. 10, for brevity). For example, based on the screen content stabilization control scheme shown in FIG. 3, the processing circuit 110 may perform the step of adjusting according to the reverse-movement (e.g. the operation of adjusting according to the reverse-movement).

In Step 954, the processing circuit 110 may perform a zoom in operation and adjust the screen content layout (labeled “Zoom in and adjust layout” in FIG. 10, for brevity). For example, based on the hybrid control scheme shown in FIG. 4, the processing circuit 110 may enlarge the display content(s) and may perform the step of adjusting according to the reverse-movement. For example, by utilizing the display module 120 (e.g. the touch screen), the processing circuit 110 may detect the location where the user is going to touch on the display module 120. As a result, the enlarged version of input region or the control object of the UI may be moved to the location where the user is going to touch on the display module 120, to allow the user to correctly touch the input region or the control object of the UI.

After the operation of Step 952 or the operation of Step 954 is performed, Step 930 is entered, for further processing regarding the display stabilization control. For brevity, similar descriptions for this embodiment are not repeated in detail here.

The steps shown in FIG. 10 are for illustration only. Depending on different embodiments, the steps shown in FIG. 10 may be performed in different orders, and one or more steps can be omitted from or added to the flow shown in FIG. 10. According to some embodiments, in a situation where the display contents to be adjusted comprise at least one portion (e.g. a portion or all) of a window, the screen content layout can be regarded as window layout. For brevity, similar descriptions for these embodiments are not repeated in detail here.

According to some embodiments, the processing circuit 110 may utilize the front camera of the electronic device to capture one or more images of the user, and may determine the direction of the eyesight of the user (e.g. the direction that the user is looking at) according to the one or more images of the user, to generate the detection signal from the aforementioned at least one sensing component of the electronic device. For example, the processing circuit 110 may perform face recognition on the image (s) of the user, and further determine the normal direction of the face of the user in the image(s), to determine the direction of the eyesight of the user. In another example, the processing circuit 110 may perform face recognition on the image(s) of the user, and further determine the normal direction of the face of the user in the image (s) and determine the relative locations of the pupils of the eyes of the user with respect to the eyes respectively, to determine the direction of the eyesight of the user. For brevity, similar descriptions for these embodiments are not repeated in detail here.

In some embodiments, the operations of determining the direction of the eyesight of the user according to the one or more images of the user to generate the detection signal may be performed by an image processing circuit such as an image processing IC. For brevity, similar descriptions for these embodiments are not repeated in detail here.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing display stabilization control in an electronic device, the method comprising the steps of:
receiving a detection signal from at least one sensing component of the electronic device to determine a movement of the electronic device according to the detection signal;
determining a reverse-movement that is opposite to the movement of the electronic device; and
adjusting at least one location of at least one portion of display contents on a display module of the electronic device according to the reverse-movement, to emulate a stabilized version of the at least one portion of the display contents for a user of the electronic device.

2. The method of claim 1, further comprising:
before determining the movement of the electronic device, receiving a previous detection signal from the at least one sensing component of the electronic device to detect an initial orientation of the electronic device,
wherein the movement of the electronic device is determined with respect to the initial orientation of the electronic device.

3. The method of claim 2, wherein the step of receiving the detection signal from the at least one sensing component of the electronic device to determine the movement of the electronic device according to the detection signal further comprises:
receiving the detection signal from the at least one sensing component to determine a temporary orientation of the electronic device; and
comparing the temporary orientation with the initial orientation to determine the movement of the electronic device.

4. The method of claim 2, wherein the initial orientation of the electronic device comprises at least one initial angle of at least one axis of the electronic device with respect to a coordinate system of real space.

5. The method of claim 1, wherein the movement of the electronic device comprises one or a combination of at least one rotation vector and at least one shift vector; and the reverse-movement comprises at least one vector that reduces or cancels at least one of the at least one rotation vector and the at least one shift vector.

6. The method of claim 1, wherein the step of adjusting according to the reverse-movement reduces or cancels a blur effect corresponding to the movement of the electronic device for the user.

7. The method of claim 1, further comprising:
detecting whether at least one condition of the electronic device is satisfied to determine whether to trigger the step of adjusting according to the reverse-movement, wherein the at least one condition is related to one or a combination of a shaking frequency of the electronic device, a motion speed of the electronic device, a rotation angle of the electronic device, a predetermined application, and a predetermined button of the electronic device.

8. The method of claim 7, wherein the step of detecting whether the at least one condition of the electronic device is satisfied to determine whether to trigger the step of adjusting according to the reverse-movement comprises at least one of the following:
determining whether the shaking frequency of the electronic device reaches a predetermined frequency threshold;
determining whether the motion speed of the electronic device reaches a predetermined speed threshold;
determining whether the rotation angle of the electronic device falls within a predetermined range;
determining whether the predetermined application is running on the electronic device; and
determining whether the predetermined button of the electronic device is pressed.

9. The method of claim 1, wherein the at least one portion of the display contents comprises a control object of a user interface (UI) displayed on the display module and the display module is a touch-sensitive display module; and the method further comprises:
when adjusting the at least one location of the at least one portion of the display contents on the display module according to the reverse-movement, adjusting a location of a detection region of the control object correspondingly, to allow the user to touch the detection region without need of resisting shaking of the electronic device.

10. The method of claim 1, further comprising:
enlarging at least one portion of display contents on the display module of the electronic device.

11. An apparatus for performing display stabilization control in an electronic device, the apparatus comprising:
a processing circuit, positioned in the electronic device and coupled to at least one sensing component of the electronic device, arranged for receiving a detection signal from the at least one sensing component of the electronic device to determine a movement of the electronic device according to the detection signal, determining a reverse-movement that is opposite to the movement of the electronic device, and adjusting at least one location of at least one portion of display contents on a display module of the electronic device according to the reverse-movement, to emulate a stabilized version of the at least one portion of the display contents for a user of the electronic device.

12. The apparatus of claim 11, wherein before determining the movement of the electronic device, the processing circuit receives a previous detection signal from the at least one sensing component of the electronic device to detect an initial orientation of the electronic device, wherein the movement of the electronic device is determined with respect to the initial orientation of the electronic device.

13. The apparatus of claim 12, wherein the processing circuit receives the detection signal from the at least one sensing component to determine a temporary orientation of the electronic device, and compares the temporary orientation with the initial orientation to determine the movement of the electronic device.

14. The apparatus of claim 12, wherein the initial orientation of the electronic device comprises at least one initial angle of at least one axis of the electronic device with respect to a coordinate system of real space.

15. The apparatus of claim 11, wherein the movement of the electronic device comprises one or a combination of at least one rotation vector and at least one shift vector; and the reverse-movement comprises at least one vector that reduces or cancels at least one of the at least one rotation vector and the at least one shift vector.

16. The apparatus of claim 11, wherein the operation of adjusting according to the reverse-movement reduces or cancels a blur effect corresponding to the movement of the electronic device for the user.

17. The apparatus of claim 11, wherein the processing circuit detects whether at least one condition of the electronic device is satisfied to determine whether to trigger the operation of adjusting according to the reverse-movement, wherein the at least one condition is related to one or a combination of a shaking frequency of the electronic device, a motion speed of the electronic device, a rotation angle of the electronic device, a predetermined application, and a predetermined button of the electronic device.

18. The apparatus of claim 17, wherein when detecting whether the at least one condition of the electronic device is satisfied to determine whether to trigger the operation of adjusting according to the reverse-movement, the processing circuit performs at least one of the following:
determining whether the shaking frequency of the electronic device reaches a predetermined frequency threshold;
determining whether the motion speed of the electronic device reaches a predetermined speed threshold;
determining whether the rotation angle of the electronic device falls within a predetermined range;
determining whether the predetermined application is running on the electronic device; and
determining whether the predetermined button of the electronic device is pressed.

19. The apparatus of claim 11, wherein the at least one portion of the display contents comprises a control object of a user interface (UI) displayed on the display module and the display module is a touch-sensitive display module; and when adjusting the at least one location of the at least one portion of the display contents on the display module according to the reverse-movement, the processing circuit adjusts a location of a detection region of the control object correspondingly, to allow the user to touch the detection region without need of resisting shaking of the electronic device.

20. The apparatus of claim 11, wherein the processing circuit enlarges at least one portion of display contents on the display module of the electronic device.
